(19) United States
(12) Patent Application Publication
(10) Pub. No.: US 2008/0154617 A1
(43) Pub. Date: Jun. 26, 2008

(54) QUERY-RELATED OBJECT BASED NAVIGATION

(76) Inventor: Ilja Fischer, Bad Schoenborn (DE)

Correspondence Address: KENYON & KENYON LLP, 1500 K STREET N.W., WASHINGTON, DC, 20005, US

(21) Appl. No.: 11/614,646

(22) Filed: Dec. 21, 2006

(51) Int. Cl. G06Q 10/00

(52) U.S. Cl. 705/1

(57) ABSTRACT

Systems and methods are provided to enable object based navigation in a computer system. When a source application sends an object key to a target application, the object key may not match the primary key used by the target application. A data service is provided, which receives requests from the target application and provides one or more new object keys that link the original object key to the primary key used by the target application. In some configurations, a user may navigate by selecting multiple objects in the source application. A data service may be used to synchronize the object keys associated with the multiple selected objects where the object IDs are of different formats or types.

### BACKGROUND

Modern businesses typically use computer systems to manage their business operations. A computer system adapted for business use may include or be implemented via a portal based communications network. Such a system typically includes user terminals which permit an operator to access system services and applications executed by one or more servers. The applications often are various topic-specific applications which collectively are called the “backend applications.” Typically, each backend application provides its own set of services to network operators. Each application may include an application engine and data objects that contain user-entered content and logic representing functions to be offered by the application. Although the data stored in a first backend application may be related to data stored in another backend application, the data sets typically do not record expressly all data relationships among them.

A “front-end” application may be used to manage a user interface. The front-end application may dynamically construct user interfaces based on data from the backend applications for presentation to operators. In a typical system, the front-end application discovers from backend applications what functionality is available and develops a user interface to match, but does not have this functionality encoded in the front-end itself. As used herein, a backend application may be described as having or providing a user interface; it will be understood that such a description refers to the interface constructed by a separate front-end application based on data provided by the backend application.

Since the backend applications often do not share data or data relationships, it may be necessary to switch from one application to another to perform a series of tasks. That is, a user may have to close one interface presented by a front-end application, perform a task in a second interface, then return to the original interface to complete a task. To simplify this process, a front-end application may provide object based navigation (OBN), which allows for movement between applications by the selection of objects displayed in the user interface. The different applications may still be accessed one at a time, but OBN often allows for the application switching to be performed in a manner undetectable to the user.

The objects used in OBN generally correspond to objects utilized by the backend applications. For example, a source application may display business objects and related data such as a list of contracts. Each object may be selected to navigate to another application, such as the details related to a single contract. Additional details regarding various types of OBN are described in U.S. patent application Ser. No. 11/319,421, filed Dec. 29, 2005, Ser. No. 11/319,423, filed Dec. 29, 2005, and Ser. No. 11/319,416, filed Dec. 29, 2005, the disclosure of each of which is incorporated by reference in its entirety.

OBN may be implemented by passing a relevant ID from the source application to the target application. The ID may be an identifier associated with an object selected by a user (a source object). This may cause problems if the source application uses different IDs, ID types, or ID formats than those used by the target application. For example, the source and target applications may have been created at different times, and the newer application may use an updated ID format. As another example, the source and target applications may be created and/or maintained by different groups, business units, or service providers, each of which uses a different ID format. These differences may prevent the use of OBN, since the target application may not have services or data defined for the ID sent by the source application. There is therefore a need for systems and methods that allow for navigation between source applications and target applications that use different IDs or ID formats.

### BRIEF DESCRIPTION OF THE DRAWINGS

FIG. 1 shows a portal-based communications network according to an embodiment of the present invention.

FIG. 2A shows object based navigation according to an embodiment of the present invention.

FIG. 2B shows object based navigation according to an embodiment of the present invention.

FIG. 3 shows communications between a source application, a target application, and data services according to an embodiment of the present invention.

FIG. 4 shows communications between a source application, a target application, and data services according to an embodiment of the present invention.

FIG. 5 shows a method for object based navigation according to an embodiment of the present invention.

### DETAILED DESCRIPTION

Embodiments of the present invention provide systems and methods for use with object based navigation that allow for navigation between source applications and target applications that use different IDs or ID formats. When an operator selects an object in a source application, the source application may pass an object key to the appropriate target application. In general, the object key may be an identifier or other index that identifies the object or object type within one or more backend applications. The object key may be, for example, an object identifier (ID), a globally-unique identifier (GUID), a vendor-specific identifier, or some other identifier associated with the object. In configurations where objects are stored in a database, the object key may be the row identifier or primary key of the appropriate database or table. The target application may then compare the object key received from the source application to the primary key used by the target application. If they are of the same type, the OBN may proceed as normal. If they are different, the target application may call a data service to identify one or more object key(s) associated with the object key sent by the source application. The object key(s) returned by the data service are of the appropriate type or form for use by the target application, which may then provide new data and services based on the received key(s). That is, the data service may translate an object key of an arbitrary type to one or more object keys of a type recognized by the target application.

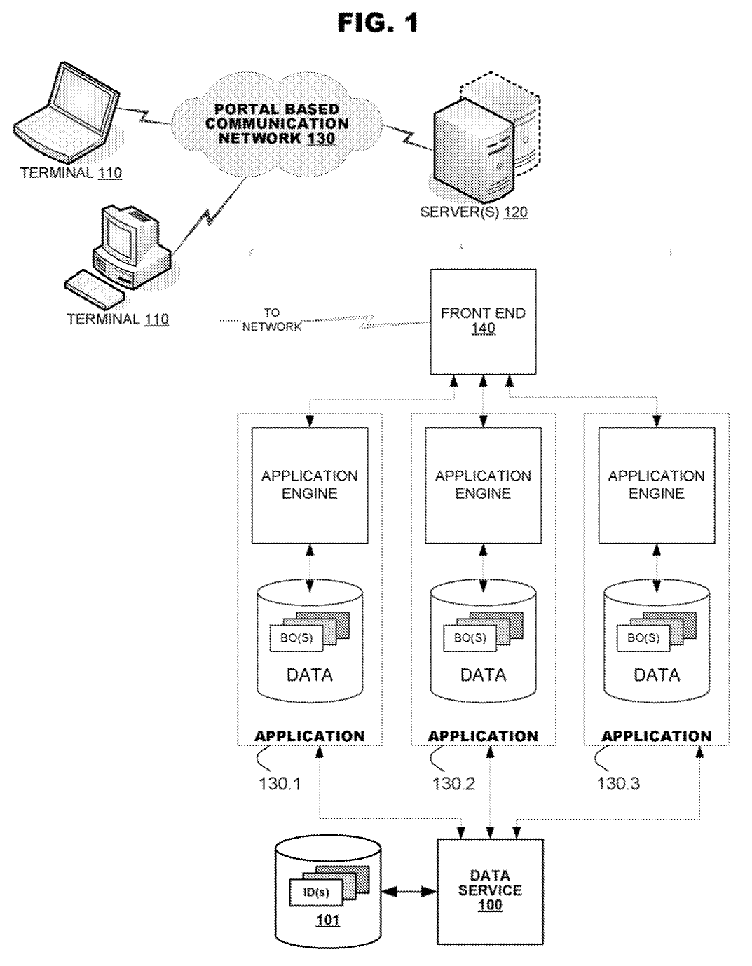

An exemplary business system suitable for use with an embodiment of the present invention is shown in FIG. 1. Using the terminals 110, an operator can access system services and applications executed by one or more servers 120. The user terminals 110 may communicate with the system via a portal based communications network 130. The applications may include various backend applications (130.1-130.3); each application may include an application engine and storage for data objects generated by the respective application. For example, FIG. 1 shows several applications and the related business objects (BOs). A front-end application 140 may dynamically construct user interfaces for presentation to operators using functionality provided by the backend applications.

As previously described, standard OBN may be implemented by passing a relevant key from the source application to the target application. If a source application sends an object key that does not match the primary key used by the target application, the target application may consult a data service 100 to determine the related keys to use in providing data and services to the front-end application. The data service 100 may store mappings between IDs, ID types, and/or ID formats in a separate database 101, or it may rely on information stored in the various applications 130.1-130.3 in the system.

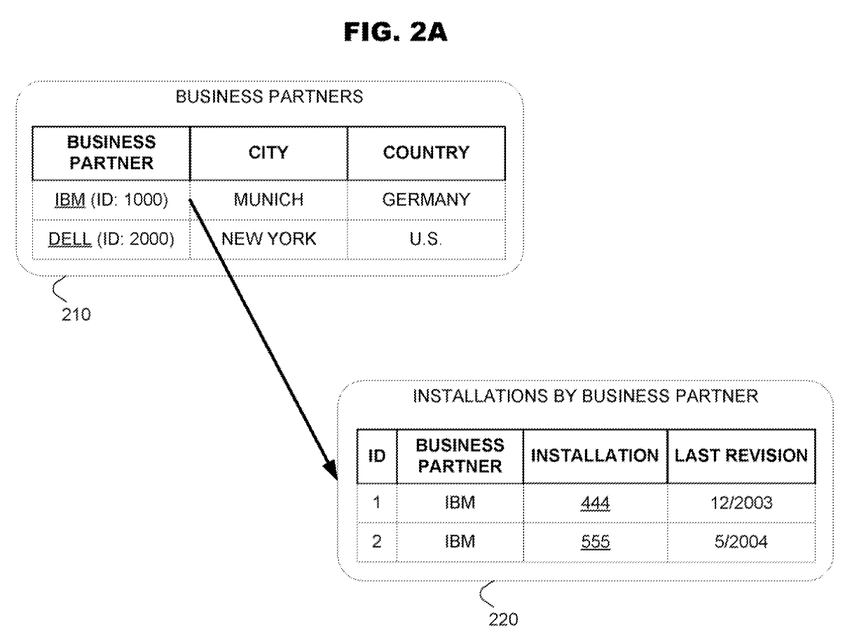

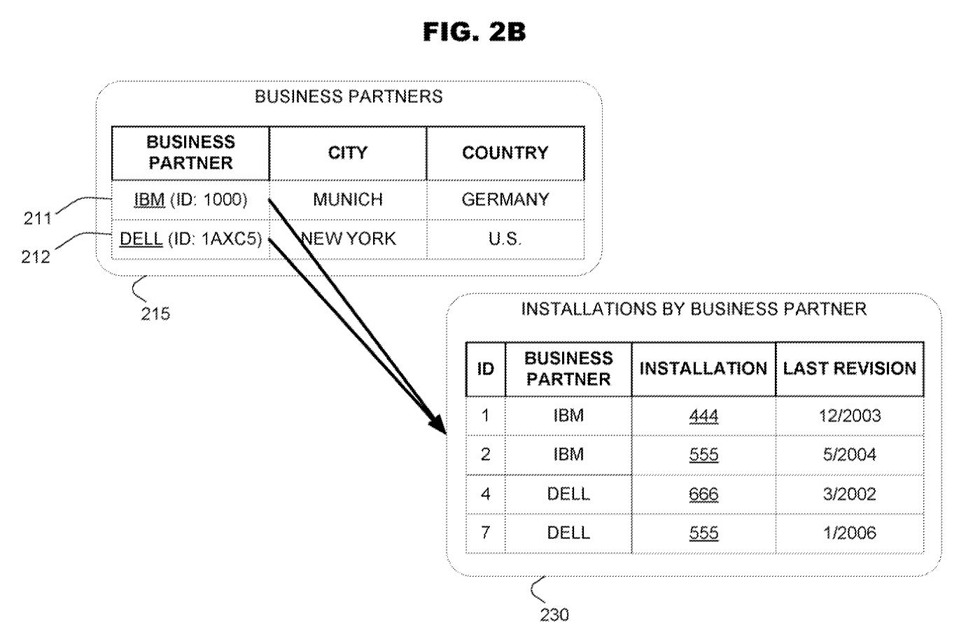

Exemplary object based navigation according to an embodiment of the present invention is shown in FIG. 2A. A source application 210 may provide, for example, a list of current business partners having installations provided by an operator of the business system. Each business partner may have one or more installations of a product. An operator may view the installations for each business partner by selecting the business partner to navigate to a target application 220. In the example, the target application 220 displays a list of installations for the selected business partner. If the source business partner application and the target installations application associate the same key with business partners, this OBN may proceed as normal. However, as shown in the example, the “Business Partners” application and the “Installations by Business Partner” application may associate different keys with the business partner object. As a specific example, the source application may identify each business partner with an ID (i.e., the business partner “IBM” has ID 1000), while the target application may identify each installation with a separate ID (i.e., the business partner “IBM” is associated with two installations having IDs 1 and 2). To enable OBN in such a situation, the target application may consult a data service to determine the appropriate object keys.

In some cases, a user may wish to select multiple source objects in a source application to perform a navigation. For example, a user may wish to view data associated with two business objects in the same target application. FIG. 2B shows an exemplary navigation where a user selects multiple objects in a source application 210. In such a navigation, the source application may send multiple requests, or a single request having multiple objects keys, to the target application. In the example shown, the source application 215 may transmit keys associated with the two selected business partners 211, 212, to a target application 230. The target application may then display data and/or services appropriate to the selected objects. In the example, the “Installations by Business Partner” application 230 displays installations for each of the business partners selected from the “Business Partners” application 215. As discussed in greater detail below, it may be desirable for a source application to consult a data service to synchronize the types of keys associated with displayed objects to enable such a navigation.

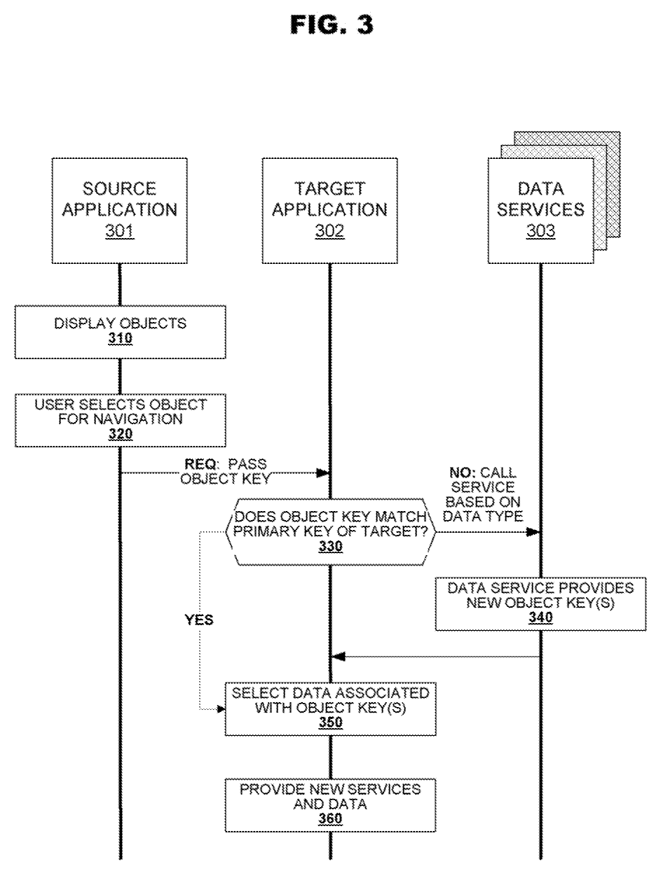

FIG. 3 shows an example process and communication stream to enable OBN according to an embodiment of the present invention. A source application 301 may display one or more objects 310. When a user wants to navigate to a second application, he may select an object 320 for which the target application functionality is desired. The source application may then send a request to the target application 302, including an object key associated with the selected object. At 330, if the object key is associated with the same type of object as the primary key of the target application, the target application may select data and services appropriate for the object key, as in normal OBN. If the same object key or key type is not used by the target application, the target application may call a data service 303 based on the data type of the selected object. For example, in the navigation described with respect to FIG. 2 the target application may call a data service associated with the data type “business partner.”

In response to a request from a target application, the data service 303 may provide one or more new object keys for use by the target application at 340. The key(s) are associated with a data type that the target application can use to provide information about the selected object. For example, the data service may provide the primary key associated with the data type of the object key sent by the source application. As a specific example, in the OBN shown in FIG. 2 the data service may provide a list of installation IDs in response to a request containing a business partner ID. At 350, the target application may then use the keys provided by the data service to provide the appropriate data and services to the front-end application.

The data service may run as part of the backend system, and may include an operation for each type of data object that can be passed from source applications. In the example shown in FIG. 2, for example, the installation application could call a service or operation dedicated to business partner installations (for example, a service such as “getInstallationsForBusinessPartner” may be used). The data service can thus respond quickly to requests from target applications, since each operation includes those data/keys related to the object type used for navigation in the source application.

Each object type may have a dedicated data service associated with it. This may be desirable to prevent storage of redundant data, reduce storage requirements, and/or reduce unnecessary requests to the data services. For example, if the associated object keys returned by the data service are instead stored with the source application data, each object in the source application may have the same data stored with it. In the example shown in FIG. 2, each business partner object would have a set of installation IDs stored in it. If there are a large number of installations, or if there are a large number of object key types to be stored, the storage requirements and associated processing time for each object could be undesirably large. It may also be undesirable for each object of the same type to store this information, since some or all of the data may be the same for each object. Similarly, if the source application calls the data services to determine appropriate object keys, it may send multiple unnecessary calls since it may send a call for each displayed object, even if the object is not selected by an operator for use in OBN.

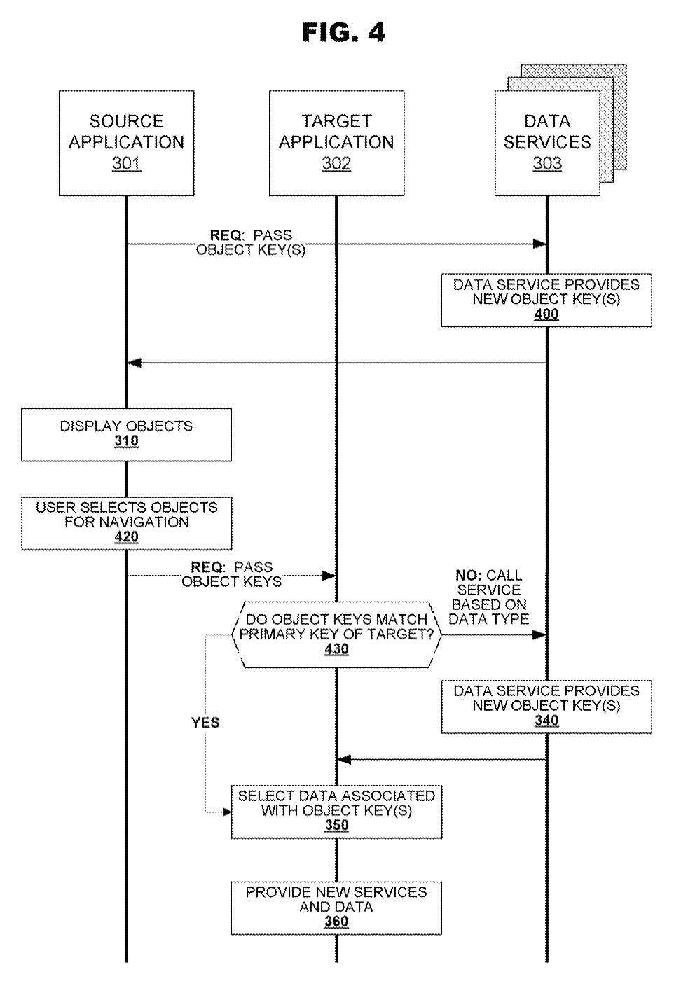

However, in some cases it may be desirable for a source application to contact a data service to determine appropriate object keys for the objects to be displayed in the source application. For example, a source application may contact a data service when it uses business objects having different types of keys. This may allow a user to navigate using multiple business objects as previously described. FIG. 4 shows an example communication stream. Unless indicated to the contrary, the steps and communications shown in FIG. 4 may be the same as those described with respect to FIG. 3, with like reference numerals denoting like communications or methods. When a source application 301 is to display navigation elements corresponding to objects, it may determine that the objects to be displayed are indexed by different types or formats of object keys. For example, in the interface shown in FIG. 2B the two business partner objects 211, 212 are associated with different types of object keys (1000 and 1AXC5). Such a difference may occur, for example, if the business partner objects were retrieved from different sources, if they were created at different times or by different vendors, or if they were retrieved from parts of the system that have varying software versions.

To synchronize the object keys, the source application 301 may send a request to a data service 303. The request may include one or more of the object keys assigned to objects to be displayed in the application. For example, if one object has a known obsolete key type, only the obsolete key may be sent. If there is no clear reason for the different key types, all the object keys may be sent. The data service consults various databases and relationships between object keys as previously described, and provides one or more new object keys to the source application (400). An operator may then select navigate to a target application 302 by selecting multiple objects in the source application (420). A request containing the object keys assigned to the selected objects is sent to the target application. At 430, the keys may be compared to the primary key of the target application as previously described, and replacement keys may be requested from a data service.

The request for new source object keys may be made at various times during the navigation, and may be made by the source application or the target application. For example, the source application may send the object keys to the target application as they exist initially, without consulting a data service. The target application may then make a single request to synchronize and correlate the object keys. This can allow the source application to process user navigation requests more quickly, but may result in increased processing time at the target application. In some cases, the target application may not be able to process all types of object keys that can be used in the source application, which may require the source application to synchronize object keys prior to sending a request to the target application. The source object request may also be performed after an operator has selected objects for navigation. This may reduce the number of requests made by the source application when a user interface is created, since a request will only be sent for those objects that require a new key and that are selected by an operator.

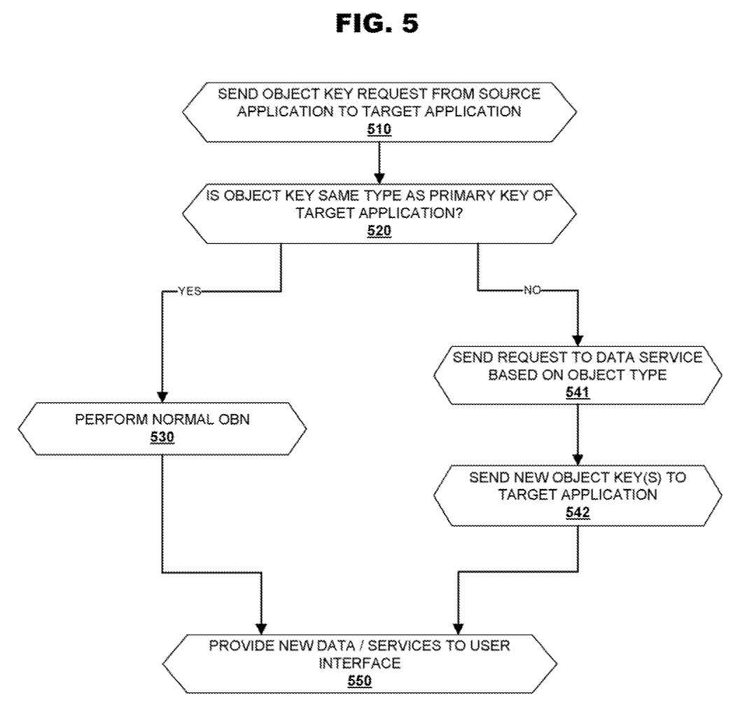

FIG. 5 shows an exemplary method of object based navigation according to the present invention. At 510, a request containing an object key associated with a selected object may be sent from a source application to a target application. At the target application, the object key may be compared to the primary key of the target application (520). If the object key type is the same as the primary key type, normal OBN is performed (530). If they are of different types, a data service may be used to enable OBN. In such a situation, the target application may send a request to a data service (541); each type of object may have an associated data service as previously described. At 542, the data service sends the appropriate new object keys to the target application, which then provides the target application data and/or services to the front-end application (550).

The various computer systems described herein may each include a storage component for storing machine-readable instructions for performing the various processes as described and illustrated. The storage component may be any type of machine readable medium (i.e., one capable of being read by a machine) such as hard drive memory, flash memory, floppy disk memory, optically-encoded memory (e.g., a compact disk, DVD-ROM, DVD±R, CD-ROM, CD±R, holographic disk), a thermomechanical memory (e.g., scanning-probe-based data-storage), or any type of machine readable (computer readable) storing medium. Each computer system may also include addressable memory (e.g., random access memory, cache memory) to store data and/or sets of instructions that may be included within, or be generated by, the machine-readable instructions when they are executed by a processor on the respective platform. The methods and systems described herein may also be implemented as machine-readable instructions stored on or embodied in any of the above-described storage mechanisms.

Although the present invention has been described with reference to particular examples and embodiments, it is understood that the present invention is not limited to those examples and embodiments. The present invention as claimed therefore includes variations from the specific examples and embodiments described herein, as will be apparent to one of skill in the art.

What is claimed is:

1. A method of providing user navigation among applications in a computer system, comprising, in response to a request from a source application, the request containing an object key of a source object:
if the object key matches the primary key of a target application, providing a user interface for the target application based on the object key; and
if the object key does not match the primary key:
sending a request to a data service associated with the object type of the source object;
in response to a new object key provided by the data service, selecting data associated with the new object key; and
providing a user interface for a target application based on the selected data.

2. The method of claim 1, wherein the data service is specific to the object type of the source object.

3. The method of claim 2, wherein the data service is one of a plurality of data services, each of the plurality of data services specific to a different object type.

4. The method of claim 1, further comprising:
if the source application is to display source objects using different object key types, sending a request to a data service, the request identifying a navigation type to be implemented in a user interface for the objects;
in response to new source object keys provided by the data service, providing a user interface including the source objects;
wherein the new source object keys are of the same type, and each of the source objects are associated with one of the new source object keys.

5. A system comprising:
storage for a plurality of source data objects;
a front-end application to provide a navigation element based on data received from a source application, the navigation element associated with a first identifier type;
a target application to store target data objects, each target data object associated with a second identifier type; and
a processor to execute a data service, the data service to provide an identifier of the second identifier type in response to a request identifying a data object type;
wherein data objects of the identified data object type are associated with identifiers of the first identifier type.

6. The system of claim 5, wherein the data service is specific to the first identifier type.

7. The system of claim 5, wherein each navigation element is specific to the data object type.

8. The system of claim 5, wherein the processor is further to execute a plurality of data services, each data service being associated with a type of navigation element.

9. A machine-readable storage medium containing program instructions for execution on a processor, which when executed by the processor cause the processor to perform, in response to a request from a source application, the request containing an object key of a source object:
if the object key matches the primary key of a target application, providing a user interface for the target application based on the object key; and
if the object key does not match the primary key:
sending a request to a data service associated with the object type of the source object;
in response to a new object key provided by the data service, selecting data associated with the new object key; and
providing a user interface for a target application based on the selected data.

10. The machine-readable storage medium of claim 9, wherein the data service is specific to the first identifier type.

11. The machine-readable storage medium of claim 9, further comprising instructions which when executed cause the processor to execute a plurality of data services.

12. The machine readable storage medium of claim 9, further comprising instructions which when executed cause the processor to execute:
if the source application is to display source objects using different object key types, sending a request to a data service, the request identifying a navigation type to be implemented in a user interface for the objects; and
in response to new source object keys provided by the data service, providing a user interface including the source objects;
wherein the new source object keys are of the same type, and each of the source objects are associated with one of the new source object keys.
